(19) United States
(12) Patent Application Publication
(10) Pub. No.: US 2010/0215040 A1
(43) Pub. Date: Aug. 26, 2010

(54) Method for Transmitting the Identity of a Multicast Message Method for Transmitting a Multicast Message for Receiving a Multicast Message and Data Packet

(76) Inventors: Cornelia Kappler, Berlin (DE); Jianming Pan, Wien (AT); Di Zhou, Wien (AT)

Correspondence Address: STAAS & HALSEY LLP, SUITE 700, 1201 NEW YORK AVENUE, N.W., WASHINGTON, DC, 20005, US

(21) Appl. No.: 12/224,669

(22) PCT Filed: Mar. 3, 2006
(86) PCT No.: PCT/DE2006/000421

§ 371 Date: May 10, 2010

(51) Int. Cl. H04L 12/56

(52) U.S. Cl. 370/390

(57) ABSTRACT

A simple and powerful method transmits an identity of a multicast message from a transmitter to several receivers, connected to the transmitter by a common transmission medium. The identity is assigned to the multicast message. A broadcast message is generated, containing the identity and pre-determined addresses specifying the receivers of the multicast message. The broadcast message is transmitted from the transmitter to all receivers connected to the receiver by the transmission medium. The broadcast message is checked by the receivers for storage of the identity by the receivers specified by the addresses thereof.

### CROSS REFERENCE TO RELATED APPLICATIONS

This application is based on and hereby claims priority to International Application Number PCT/DE2006/000421, filed on Mar. 3, 2006, the contents of which are hereby incorporated by reference.

### BACKGROUND OF THE INVENTION

More and more different types of both mobile and cable-based communication networks with completely different characteristics and parameters are currently being designed, developed and used. In this case, inter alia, there is a need to allow efficient and automated interaction between these communication networks. For this purpose, it is necessary for a communication network to signal its characteristics, for example with respect to its identity or the services or resources supported or required by it, to further communication networks in its vicinity, or for these further communication networks to request it to signal its corresponding characteristics to them.

In general, this raises the question as to how electronic messages, in particular in the form of so-called multicast messages, can be transmitted in the future when required in a manner which is as efficient as possible to terminals and/or network nodes in communication networks.

Multicast, in some cases also referred to by the expression “conference call”, refers to the transmission of an electronic message, or copies of the electronic message with identical contents, from one transmitter to a group comprising a plurality of recipients. In this case, the electronic message is advantageously transmitted in such a way that the transmitter does not transmit a separate copy of the electronic message for each of the recipients of the electronic message. This means that, in general, only one bandwidth is required at the transmitter end when using a multicast method, which bandwidth is identical to those when transmitting the electronic message to a single recipient, that is to say the required bandwidth is not scaled with the number of recipients.

Existing methods for transmission of a multicast message, such as the method known from the document “3GPP TS 22.146 V7.0.0 (2005-12); 3rd Generation Partnership Project; Technical Specification Group Services and System Aspects; Multimedia Broadcast/Multicast Service; Stage 1 (Release 7)” are generally based on an identity of a multicast message, which is also referred to as a multicast address, being defined and assigned to a group of recipients. In this case, it is necessary for both the transmitter of the multicast message and the recipients of the multicast message to have the information about the identity of the multicast message. Appropriate registration of the recipients is necessary for this reason, before a multicast message can be transmitted.

Corresponding methods are therefore suitable essentially only for static applications, for example television or radio transmissions whose nature means that there are medium-term or long-term associations between recipients and a multicast group. In applications such as these, there is normally no need for the transmitter of the multicast message.

To have information about characteristics of the recipients. Furthermore, from the point of view of the transmitter, there is also no need to ensure that all the potential recipients of a multicast message are informed of the corresponding identity of the multicast message, and thus can actually receive the multicast message.

For the stated reasons, the applicability of the methods as described above and based on an identity is restricted to transmission of a multicast message in such a way that these methods are not suitable for supporting short-term and dynamic applications. For example, multicast therefore cannot be used for the purpose of signaling, that is to say for transmission of signaling and/or control messages between components of a communication network or else to the components of a plurality of communication networks, since applications in the field of signaling are normally requirement-dependent and dynamic, and therefore necessitate immediate message transmission. In situations such as these, it is therefore in general not possible to distribute at the right time an identity that has been assigned to a multicast message to be transmitted, to all the potential recipients of that multicast message.

Furthermore, a situation can also occur in which the transmitter of the multicast message is interested in information about the potential recipients of the multicast message. In this case, for example, this may relate to information concerning specific characteristics such as the spatial distribution or the precise location of the recipients. Furthermore, it is feasible for the transmitter of the multicast message to wish to ensure even before transmission that all the potential recipients of the multicast message have the identity and can therefore receive the multicast message to be transmitted.

### SUMMARY

It is one possible object to specify a simple and powerful method for transmission of the identity of a multicast message.

The inventors propose a method for transmission of an identity of a multicast message from a transmitter to a plurality of recipients, which are connected to the transmitter via a common transmission medium, having the following steps: assignment of the identity to the multicast message, production of a broadcast message which contains the identity as well as the addresses which identify predetermined recipients of the multicast message, transmission of the broadcast message from the transmitter to all the recipients connected to the transmitter via the common transmission medium, checking of the broadcast message by the recipients, and storage of the identity by the recipients predetermined by the identifying addresses.

The proposed method offers the advantage that the identity of the multicast message is transmitted by the broadcast message from the transmitter to all the recipients linked to the transmitter via the common transmission medium. In this case, the broadcast message contains not only the identity of the multicast message but, furthermore, also addresses which identify predetermined recipients of the multicast message. This makes it possible for all the recipients connected to the transmitter via the common transmission medium to evaluate the addresses contained in the broadcast message. If the corresponding check by a recipient of the broadcast message indicates that the broadcast message contains an address associated with this recipient, then this recipient stores the identity which is contained in the broadcast message. The method therefore advantageously makes it possible to distribute the identity of the multicast message within a very short time from the transmitter to the recipients connected to the transmitter via a common transmission medium. In this case, it is possible for the transmitter to predetermine recipients of the multicast message. This advantageously creates the precondition for subsequent transmission to the predetermined recipients of the multicast message which is identified by the identity.

Furthermore, the inventors propose a method for transmission of a multicast message.

The proposed method for transmission of a multicast message from a transmitter to a plurality of recipients connected to the transmitter via a common transmission medium, having the following steps: assignment of an identity to the multicast message, production of a broadcast message which contains the identity as well as the addresses which identify predetermined recipients of the multicast message, transmission of the broadcast message from the transmitter to all the recipients connected to the transmitter via the common transmission medium, checking of the broadcast message by the recipients, storage of the identity by the recipients predetermined by the identifying addresses, transmission of the multicast message via the common transmission.

Medium by the transmitter, with the multicast message containing the identity, and reception of the multicast message by the predetermined recipients on the basis of the identity.

The method for transmission of a multicast message is advantageous since it allows the recipients of the multicast message to be defined at short notice at the transmitter end. For this purpose, the identity associated with the multicast message (or this multicast message and possibly subsequent multicast messages to the same recipients, that is to say a multicast group) is transmitted by the broadcast message to all the recipients connected to the transmitter via the common transmission medium.

In this case, the common transmission medium offers the advantage that all the recipients of the broadcast message receive this message immediately and virtually simultaneously. It is therefore possible for the recipients to use the addresses which are transmitted in the broadcast message and identify the predetermined recipients to check whether they are intended to be recipients of the multicast message. If this is the case, the relevant recipient of the broadcast message stores the identity. Subsequently received multicast messages are filtered by the recipients on the basis of the identity which is contained in the respective multicast message, that is to say a recipient processes only those multicast messages which contain an identity which has been stored by it.

One advantageous refinement of the method is distinguished by transmission of at least one further multicast message, which contains the identity, via the common transmission medium, and reception of the at least one further multicast message by the predetermined recipients on the basis of the identity. This development of the method is preferred since there is no need to retransmit the identity by a broadcast message when transmitting further multicast messages which contain the identity. After the identity has been distributed once by the broadcast message, multicast messages can therefore be sent in the normal manner. This means that the maximum number of messages which are required to transmit one multicast message is two. As a result of the existing capability to transmit further multicast messages with the same identity, the average number of required messages is, however, generally less than two.

In one preferred embodiment, the method is configured such that a medium in the data link layer is used as the common transmission medium. The use of a medium in the data link layer is preferred as a common transmission medium since, in the case of the protocol stacks that are normally used, for example as implemented in accordance with the OSI (Open Systems Interconnection) model, the data link layer (layer 2, also referred to as the link layer) is generally in the form of a common transmission medium.

In a further preferred embodiment of the method, a radio transmission channel is used as the common transmission medium. This is advantageous since this allows the method to be used for transmission of a multicast message even for recipients connected to the transmitter wirelessly via a mobile radio network.

The method can preferably also be distinguished by use of a data bus as the common transmission medium. In the case of transmitters and recipients connected to one another by cable, a data bus is a conventional and powerful common transmission medium.

In a further development of the method, a signaling message is used as the multicast message. In this case, signaling messages are those messages by which control or monitoring information is transmitted between different network nodes or terminals in a communication network or a plurality of communication networks. The use of a signaling message as a multicast message is preferred since the method advantageously actually also allows signaling messages to be used for transmission in the form of a multicast message.

In a further advantageous embodiment, the method can also be carried out in such a way that IP (Internet Protocol) or MAC (Media Access Control) addresses are used as identifying addresses. IP and MAC addresses are conventional addresses for addressing recipients. In this case, MAC addresses are associated with the data link layer (layer 2), and IP addresses are associated with the network layer (layer 3), which is arranged above the data link layer in the protocol stack. Both IP addresses and MAC addresses can therefore advantageously be used as identifying addresses.

The method is preferably configured such that the broadcast message is used to identify whether IP or MAC addresses are contained as identifying addresses. This makes it possible for the recipients of the broadcast message to identify in a simple manner that the broadcast message is a message which contains identifying addresses and an identity, and which type of addresses is contained in the broadcast message. This advantageously makes it easier for the recipients to check the identifying addresses.

In one preferred development of the method, a data packet with a header and a data container (body) is used as the broadcast message. This embodiment is advantageous since data packets represent the normally used form of messages in conjunction with a packet-switched data transmission. In this case, a single data packet is preferably sufficient for use as a broadcast message, which means that the amount of data to be transmitted is kept small. However, as an alternative to this, it is also possible to use a plurality of data packets, which are identified as being associated, as a broadcast message, for example in a situation in which a large number of identifying addresses make it necessary to use more than one data packet for information transmission.

The method is preferably distinguished in that the identifying addresses of the predetermined recipients are transmitted in the data container. Transmission of the identifying addresses of the predetermined recipients in the data container is advantageous since sufficient capacity to accommodate the identifying addresses is normally available in the data container.

The method can also advantageously be carried out in that validity duration of the identity is indicated in the broadcast message. This offers the advantage that an identity can therefore be deleted from the respective recipients once the validity duration has elapsed. This avoids an identity having to be stored for an unlimited time by predetermined recipients once they have stored it. Furthermore, a new specific message can preferably be introduced in order to lengthen the validity duration of the identity.

Any desired existing or future protocol standards for wireless or cable-based technologies, in particular the data link layer, which use a common transmission medium may be used for transmission of the broadcast message and the multicast message. Examples that may be mentioned include GSM (Global System for Mobile Communications), WCDMA (Wideband Code Division Multiple Access), TD-WCDMA (Time Division Synchronous Code Division Multiple Access) and WiMAX (Worldwide Interoperability for Microwave Access). In one particularly preferred development of the method, the broadcast message and the multicast message are transmitted using the Ethernet (IEEE802.3) Standard or the Wireless Local Area Network (WLAN, IEEE802.11) Standard. The use of the Ethernet or the WLAN Standard for the transmission of the broadcast message and the multicast message is preferred since these two standards represent widely used protocol standards for the datalink layer in cable-based and wireless communication networks.

In a further advantageous development, the method is carried out in such a way that, when using a broadcast message in the form of a data packet with a header and a data container, and when transmitting the identifying addresses of the predetermined recipients in the data container, the “type” parameter is used to indicate whether the identifying addresses are IP or MAC addresses of the predetermined recipients. This is advantageous since the “type” parameter, which already exists in the Ethernet and WLAN Standards can be used to indicate the type of identifying addresses which are transmitted in the data container. Two new protocol types are preferably introduced for this purpose, together with corresponding formats of the data container. In this case, when MAC addresses are transmitted in the data container, the identifying addresses of about 250 recipients can be transmitted in one broadcast message, which comprises one data packet. If this is not adequate, then, for example, additional data packets can be linked by addition of one or more control bits.

The inventors also propose an apparatus for transmission of a multicast message to a plurality of recipients linked to the apparatus via a common transmission medium, having a management device for assignment of an identity to the multicast message, a packet data production device for production of the multicast message which contains the identity, a broadcast packet production device for production of a broadcast message which contains the identity and a plurality of addresses which identify predetermined recipients of the multicast message, as well as a packet transmission device for transmission of the broadcast message to all the recipients linked via the common transmission medium, and for transmission, at a time offset with respect to this, of the multicast message to the recipients predetermined by the identifying addresses.

The apparatus for transmission of a multicast message offers the advantage that it makes it possible to produce a broadcast message which contains addresses which identify the identity and a plurality of predetermined recipients of the multicast message. Since the packet transmission device is used to transmit the broadcast message to all the recipients linked via the common transmission medium, the identity of the multicast message can be distributed at short notice and quickly to the recipients intended by the transmitter.

In general, it should be noted that the components of the apparatus are essentially logic units. This means that these logic units are defined substantially by their function. For example, a plurality of the components can thus also be provided by the same hardware or software component. Conversely, however, one or more of the components may also be implemented in the form of a plurality of hardware or software components.

The inventors further propose an apparatus for reception of a multicast message, with the multicast message being intended for a plurality of recipients linked to a transmitter via a common transmission medium, having a receiving device for reception of a broadcast message and of the multicast message, a broadcast processing device for analysis of whether the received broadcast message contains an address which identifies the apparatus and, if appropriate, for reading an identity from the relevant broadcast message, as well as a multicast processing device for storage of the identity which is transmitted by the broadcast processing device, and for filtering and reception of multicast messages which contain the identity.

The apparatus for reception of a multicast message is preferred since, with the broadcast processing device, it has a component for analysis of whether the received broadcast message contains an address which identifies the apparatus, and if appropriate for reading the identity from the relevant broadcast message. This makes it possible to use the broadcast message to distribute the identity of the multicast message to a recipient in the form of the apparatus. This is formed by the multicast processing device for storage of the identity, which is transmitted by the broadcast processing device, and for filtering and reception of multicast messages which contain the identity. The apparatus is therefore advantageously designed such that it allows the reception of multicast messages at short notice.

Still further, the inventors propose a data packet for transmission of a broadcast message with a header and a data container (body), with the data container of the data packet having an identity for identification of multicast messages as well as addresses which identify predetermined recipients associated with the identity.

The data packet is preferred since it allows the transmission of a broadcast message with the data container of the data packet having not only the identity for identification of multicast messages but, furthermore, also predetermined addresses which identify recipients associated with the identity. The data packet is therefore advantageously designed for distribution of the identity to recipients predetermined at the transmitter end.

The data packet is preferably configured such that the data packet has IP (Internet Protocol) or MAC (Media Access Control) addresses as identifying addresses. This embodiment of the data packet is advantageous since IP and MAC addresses are addresses that are used frequently at the level of the data link layer (layer 2) and the network layer (layer 3), respectively.

In one advantageous development, the data packet contains information as to whether the data packet has IP (Internet Protocol) or MAC (Media Access Control) addresses as identifying addresses. This offers the advantage that the recipient of the data packet can determine in a simple manner whether the data packet has identifying addresses and, if appropriate, the type of identifying addresses involved.

In one preferred embodiment, the data packet is formed in accordance with Ethernet (IEEE802.3) or WLAN (IEEE802.11) specifications. This embodiment of the data packet is preferred because the Ethernet and WLAN are widely used, powerful protocol standards for the data link layer.

The data packet can advantageously be distinguished in that, in the case of a data packet with identifying addresses in the form of IP (Internet Protocol) or MAC (Media Access Control) addresses, the “type” parameter in the data container of the data packet indicates whether the data packet has IP (Internet Protocol) or MAC (Media Access Control) addresses as identifying addresses. This offers the advantage that it is possible to indicate in the data packet, without the addition of a new parameter, that is to say with only a minor extension to the existing protocol, whether the data packet has IP or MAC addresses as identifying addresses.

In general, it should be noted that the present invention can advantageously be used in conjunction with a further invention which is known from a further patent application from the same applicant (date of filing: 2 Mar. 2006, internal file reference: 2006E02630AT), which in particular specifies a method and an apparatus for transmission of an electronic message.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a flowchart, in the form of a schematic sketch, in order to explain one exemplary embodiment of the apparatus for transmission of a multicast message, as well as one exemplary embodiment of the proposed method, with regard to its transmitter-end steps for transmission of this multicast message,

FIG. 2 shows a flowchart, in the form of a schematic sketch, in order to explain one exemplary embodiment of the proposed apparatus for reception of a multicast message, as well as one exemplary embodiment of the method with regard to its steps at the recipient end for transmission of the multicast message, and

FIG. 3 shows a schematic sketch of one exemplary embodiment of the proposed data packet.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

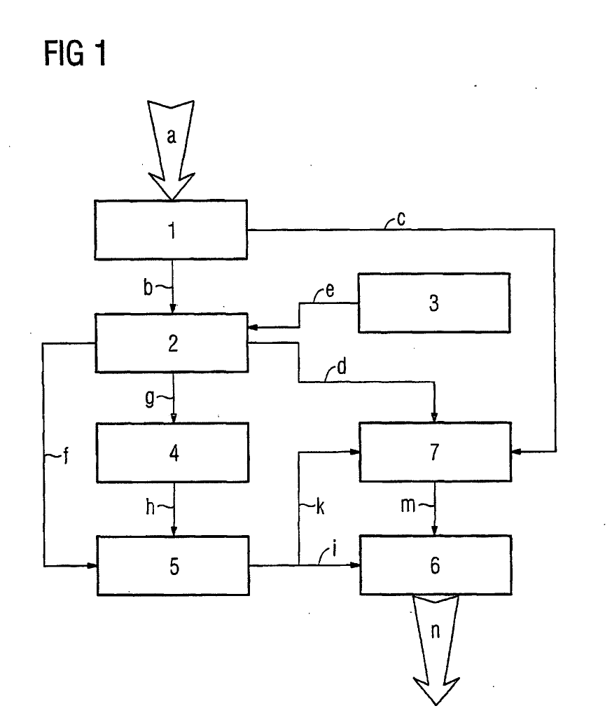

FIG. 1 shows a flowchart, in the form of a schematic sketch, in order to explain one exemplary embodiment of the proposed apparatus for transmission of a multicast message, as well as one exemplary embodiment of the method, with regard to its transmitter-end steps for transmission of this multicast message. In this case, the individual blocks represent logic components of the apparatus, and the arrows between the blocks indicate the message flow or information flow between the components.

In the exemplary embodiment illustrated in FIG. 1, a control device which is responsible for routing at the network layer level decides to distribute a signaling message by a multicast message in the data link layer. For this purpose, the control device passes to the network layer the relevant data, that is to say the content of the multicast message as well as the addresses, which identify the recipients of the multicast message, in the network layer, to the illustrated apparatus, in the form of a control device at the data link layer level. In this case, the two control devices may, for example, be a component of a router.

A preprocessor 1 of the control device at the data link layer level receives the data in the multicast message, analyses this data and passes the addresses in the network layer on to an address checking device 2, by message or step b. The content of the multicast message, which is also referred to as the “link layer payload data” is transmitted by the preprocessor 1 in step c to a packet data production device 7, for further processing.

After reception of the addresses in the network layer from the preprocessor 1, the address checking device 2 checks whether a valid identity for transmission of a multicast message exists for the received addresses in the network layer, that is to say for the group of addresses in the network layer and the multicast group defined by these addresses. If this is the case, the address checking device 2 transmits this identity to the packet data production device 7, in step d.

Otherwise a management device 3 is activated in a step which is not illustrated in FIG. 1, for clarity reasons. This management device 3 assigns an identity to the multicast message to be transmitted and/or to the addresses in the network layer. In this case, the management device 3 provides the identity with a validity duration, which may be considered to be a component of the identity itself, and transmits the identity to the address checking device 2 in step e.

The object of the management device 3 is therefore to assign new at least locally unique identities for transmission of a multicast message, and to assign a validity duration to the corresponding identities. In this case, the validity duration may be calculated in many different ways. In addition to the ability to delete identities again once they have been produced, the use of a validity duration offers the advantage that this ensures that new identities are available at all times. In this case, it should be noted that the identities also preferably lose their validity when the configuration at the data link layer (that is to say the local link) changes.

The address checking device 2 transmits the new identity (together with the validity duration) to a broadcast packet production device 5, in step f. Furthermore, in step g, it sends the addresses in the network layer to an address translation device 4.

The address translation device 4 translates the addresses in the network layer to corresponding addresses in the data link layer, that is to say in the present case to MAC addresses, and sends these to the broadcast packet production device 5 for further processing in step h. A corresponding function of address translation is supported by most commonly used protocols for the data link layer. The address translation may be inhibited if the broadcast packet production device 5 does not use the MAC addresses, but the addresses in the network layer, for example in the form of IP addresses.

The broadcast packet production device 5 produces a broadcast message in the form of a specific broadcast data packet in the data link layer, containing both the addresses in the data link layer, as received by the address translation device 4 in step h, and the identity of the multicast message, as received by the address checking device 2 in step f. As already explained above, it is also possible as an alternative to this for the broadcast packet production device 5 to insert the IP addresses directly, rather than the MAC addresses, into the data packet.

The broadcast message that is produced is transmitted in step i from the broadcast packet production device 5 to a packet transmission device 6.

Furthermore, in step k, the broadcast packet production device 5 transmits the identity of the multicast message to the packet data production device 7. In this case, advantageously, a timer which identifies a time delay is transmitted to the packet data production device 7 in addition to the multicast message. The timer in this case indicates the time which should be allowed to lapse between the transmission of the broadcast message and the sending of the multicast message. Alternatively, this timer may also already be stored as a parameter in the packet data production device 7 or in the packet transmission device 6.

The packet data production device 7 now produces a multicast message in the data link layer, which message contains the identity and the data, as received by the preprocessor 1 in step c, in the multicast message. The packet data production device 7 then waits for the time as predetermined by the received timer to elapse, in order to ensure that all the recipients connected via the common transmission medium have already received and processed the broadcast message in the form of the specific data packet.

The packet data production device then passes the multicast message that has been produced on to the packet transmission device 6, in step m. If, in step d, the packet data production device 7 receives from the address checking device 2 an identity which already exists in the multicast message, the packet data production device 7 produces the multicast message without any time delay, and passes it on directly to the packet transmission device 6. In this case, the identity of the multicast message will have already been distributed by a broadcast message, for example in conjunction with a previous multicast message, and will have been processed by the predetermined recipients, so that there is no need to transmit the broadcast message again.

The object of the packet transmission device 6 is to pass the broadcast message, received by the broadcast packet production device 5 in step i, and the multicast message, received by the packet data production device 7 in step m, to the common transmission medium, that is to say to send the relevant messages to all the recipients connected to the transmission medium. This is indicated by step n, and is carried out in a manner corresponding to the sequence in which the messages are received. In this case, the broadcast message is intended to be received and checked by all the recipients connected to the common transmission medium. If one recipient finds its own MAC address or its own IP address in the received broadcast message, then this recipient prepares itself to receive a multicast message or a plurality of multicast messages with the relevant identity.

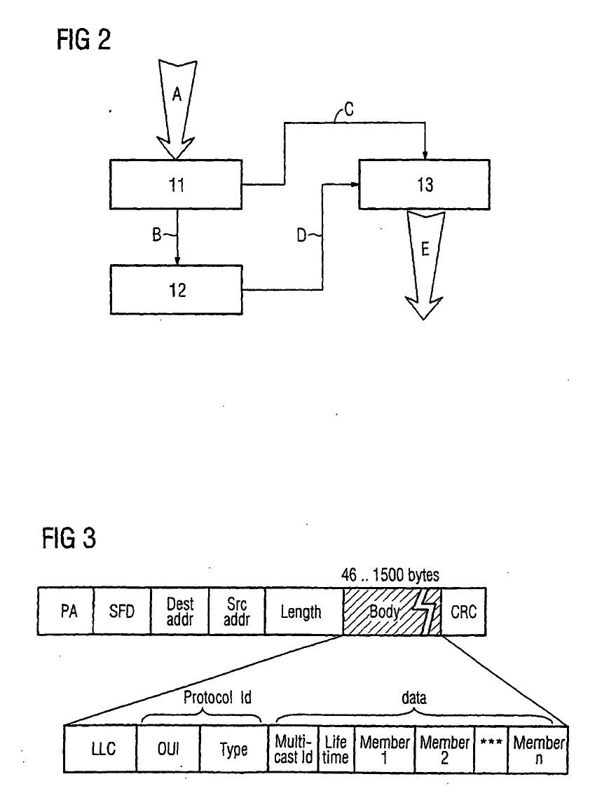

FIG. 2 shows a flowchart, in the form of a schematic sketch, in order to explain one exemplary embodiment of the proposed apparatus for reception of a multicast message, as well as one exemplary embodiment of the proposed method, with regard to its steps at the recipient end for transmission of the multicast message.

In the exemplary embodiment illustrated in FIG. 2, a receiving device 11 is designed to receive broadcast and multicast messages via a common transmission medium in the data link layer. This is indicated by step A and may, for example, be carried out by appropriate data packets.

The receiving device 11 passes received broadcast messages to a broadcast processing device 12 in step B, and passes received multicast messages to a multicast processing device 13 in step C.

The broadcast processing device 12 identifies the received broadcast message on the basis of a predetermined identification as a broadcast message of the type by which an identity of a multicast message is distributed. If, for example, the payload data in the broadcast message contains the address in the data link layer, for example, in the form of the MAC address or the address in the network layer for example in the form of the IP address which are associated with the apparatus, then, in step D, the broadcast processing device 12 passes the identity that has been read from the broadcast message on, together with an associated validity duration, to the multicast processing device 13.

After reception of the identity and the validity duration from the broadcast processing device 12, the multicast processing device 13 stores the identity and the associated validity duration until the time local ab, until either the validity duration has elapsed or the configuration at the data link layer level changes, that is to say that the configuration of the recipients connected via the common transmission medium.

Whilst the receiving device 11 has received the multicast message in step C, the multicast processing device 13 checks whether the received identity is an identity which it has stored locally. If this is the case, in step E, the multicast processing device 13 passes on the payload data in the multicast message to a control device in the local network layer, which is at a higher level in the protocol stack. In consequence, the relevant multicast message can be analyzed and evaluated by the apparatus or by the recipient associated with the apparatus.

FIG. 3 shows one exemplary embodiment, in the form of a schematic sketch, of the proposed data packet for transmission of a broadcast message. In this case, the upper part of the figure shows an overview of the structure of the data packet, and the lower part shows a more detailed illustration of the data container, which is also referred to as the body, of the data packet.

In the exemplary embodiment illustrated in FIG. 3, the data packet is formed in accordance with the Ethernet Standard requirements. In this case, the “type” parameter which is provided in the Ethernet Protocol is advantageously placed in the data container by one of two new protocol types which specify the respective Ethernet broadcast data packet. In this case, one of the two new protocol types indicates that the data container contains IP addresses, while the other new protocol type specifies that the data container contains MAC addresses. As already stated above, approximately 250 recipient addresses can be transmitted by one Ethernet data packet. In this case, the addresses which identify the predetermined recipients are indicated in FIG. 3 as “Member 1” . . . “Member N”.

The “life time” parameter illustrated in the data container contains details relating to the validity duration of the identity transmitted by the broadcast message, as indicated in the figure as “multicast-ID”. A new message is advantageously introduced in the Ethernet protocol, by which it is possible to extend the validity duration of an identity.

In order to transmit the multicast message itself, a multicast message which is known per se in the Ethernet protocol can be used after transmission of the broadcast message in the form of the data packet as illustrated in FIG. 3.

In a corresponding manner to the above statements, the foregoing proposals advantageously make it possible to also send signaling messages by multicast messages. Furthermore, the automatic setting up of different multicast groups, that is to say the assignment of an identity to a multicast message or to a plurality of recipients, is made possible, without any need for explicit registration at the recipient end. This offers the advantage that messages can also be transmitted at short notice by a multicast message to a plurality of predetermined recipients. In this case, instead of sending separate copies of the same electronic message to different recipients, just one broadcast message and one multicast message is sent via the common transmission medium. In this case, the broadcast message is required just once, in order to set up the new multicast group in the data link layer.

The foregoing can advantageously be used in conjunction with any desired protocols and methods in the data link layer.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-22. (canceled)

23. A method for transmission, comprising:
assigning an identity to a multicast message;
producing a broadcast message which contains the identity and addresses which identify predetermined recipients of the multicast message;
transmitting the broadcast message via a common transmission medium, the broadcast message being transmitted from a transmitter to all recipients connected to the transmitter via the common transmission medium;
checking the broadcast message by the recipients; and
storing the identity at the predetermined recipients having respective addresses contained in the broadcast message.

24. The method for transmission according to claim 23, further comprising:
transmitting the multicast message via the common transmission medium from the transmitter, the multicast message containing the identity; and
receiving the multicast message at the predetermined recipients on the basis of the identity.

25. The method as claimed in claim 24, further comprising:
transmitting at least one further multicast message, which contains the identity, via the common transmission medium; and
receiving the at least one further multicast message by the predetermined recipients on the basis of the identity.

26. The method as claimed in claim 23, wherein a medium in a data link layer is used as the common transmission medium.

27. The method as claimed in claim 23, wherein a radio transmission channel is used as the common transmission medium.

28. The method as claimed in claim 23, wherein a data bus is used as the common transmission medium.

29. The method as claimed in claim 23, wherein a signaling message is used as the multicast message.

30. The method as claimed in claim 23, wherein the addresses which identify the predetermined recipients are Internet Protocol (IP) or Media Access Control (MAC) addresses.

31. The method as claimed in claim 30, wherein the broadcast message specifies whether Internet Protocol (IP) or Media Access Control (MAC) addresses are used as the addresses which identify the predetermined recipients.

32. The method as claimed in claim 23, wherein a data packet with a header and a data container is used as the broadcast message.

33. The method as claimed in claim 32, wherein the addresses which identify the predetermined recipients are transmitted in the data container.

34. The method as claimed in claim 23, wherein the broadcast message specifies for a validity duration period during which the recipient identified by the identity is permitted to receive the multicast message.

35. The method for transmission according to claim 34, further comprising automatically deleting the stored identity after the validity duration period.

36. The method as claimed in claim 23, wherein the broadcast message and the multicast message are transmitted using an Ethernet Standard or a Wireless Local Area Network Standard.

37. The method as claimed in claim 36, wherein
the broadcast message is a data packet with a header and a data container,
the data packet has a type parameter,
the addresses which identify the predetermined recipients are transmitted in the data container, and
the type parameter is used to indicate whether the addresses which identify the predetermined recipients are Internet Protocol (IP) or Media Access Control (MAC) addresses.

38. The method for transmission according to claim 24, wherein the multicast message is processed only if the identity of the broadcast message matches the stored identity.

39. An apparatus for transmission, comprising:
a management device to assign an identity to a multicast message;
a packet data production device to produce the multicast message such that the multicast message contains the identity;
a broadcast packet production device to produce a broadcast message which contains the identity and a plurality of addresses which identify predetermined recipients of the multicast message; and
a packet transmission device to transmit the broadcast message to all recipients linked to the apparatus via a common transmission medium, and to transmit the multicast message at a time offset with respect to transmission of the broadcast message, the multicast message being transmitted via the common transmission medium to the predetermined recipients predetermined.

40. A receiver apparatus, comprising:
a receiver to receive a broadcast message and a multicast message, both the broadcast message and the multicast message being received via a common transmission medium;
a broadcast processing device to analyze whether the broadcast message contains an address which identifies the apparatus and, if the broadcast message does contain the address which identifies the apparatus, to read an identifier for the multicast message, the identifier being contained in the broadcast message; and
a multicast processing device to store the identifier, and to filter received multicast messages to filter out all broadcast messages not having an identifier matching the stored identifier.

41. The receiver apparatus according to claim 40, wherein the broadcast processing device reads the identifier for the multicast message only if the broadcast message contains the address which identifies the apparatus

42. A broadcast message data packet for transmission, comprising:
a header; and
a data container, the data container of the data packet containing an identifier that identifies multicast messages, the data container also containing addresses which identify predetermined recipients for the broadcast messages identified by the identifier.

43. The data packet as claimed in claim 42, wherein the addresses in the data container of the data packet are Internet Protocol (IP) or Media Access Control (MAC) addresses.

44. The data packet as claimed in claim 43, wherein the data packet contains information specifying whether the addresses are Internet Protocol (IP) or Media Access Control (MAC) addresses.

45. The data packet as claimed in claim 42, wherein the data container in the data packet specifies a validity duration period for the identifier and the addresses.

46. The data packet as claimed claim 42, wherein the data packet is an Ethernet data packet or a Wireless Local Area Network (WLAN) data packet.

47. The data packet as claimed in claim 46, wherein
the data packet has a type parameter,
the type parameter is used to indicate whether addresses are Internet Protocol (IP) or Media Access Control (MAC) addresses.
